(19) United States
(12) Patent Application Publication
(10) Pub. No.: US 2014/0375253 A1
(43) Pub. Date: Dec. 25, 2014

(54) METHODOLOGY FOR MULTIPLE POCKET-FORMING

(71) Applicant: DvineWave Inc., San Ramon, CA (US)

(72) Inventors: Michael A. Leabman, San Ramon, CA (US); Gregory Scott Brewer, Livermore, CA (US)

(21) Appl. No.: 13/925,469

(22) Filed: Jun. 24, 2013

(51) Int. Cl. H02J 7/02; H01F 38/14

(52) U.S. Cl. CPC H02J 7/025; H01F 38/14
USPC 320/108; 307/104

(57) ABSTRACT

The present disclosure describes a methodology for wireless power transmission based on multiple pocket-forming. This methodology may include one transmitter and two or more receivers, being the transmitter the source of energy and the receivers the devices that are desired to charge or power. Both devices, the transmitter and receiver, may communicate to each other via a wireless protocol. By communicating to each other, the transmitter may identify and locate the devices to which the receivers are connected. and thereafter aim pockets of energy to each device in order to power them.

### CROSS-REFERENCES TO RELATED APPLICATIONS

The present disclosure is related to U.S. Non-Provisional patent application Ser. No. 13/891,340 filed May 10, 2013, entitled Methodology for Pocket-Forming, the entire content of which is incorporated herein by this reference.

### FIELD OF INVENTION

The present disclosure relates to wireless power transmission, and more particularly to a method for wireless power transmission based on pocket-forming.

### BACKGROUND OF THE INVENTION

Portable electronic devices such as smart phones, tablets, notebooks and others have become an everyday need in the way we communicate and interact with others. The frequent use of these devices may require a significant amount of power, Which may easily deplete the batteries attached to these devices. Therefore, a user is frequently needed to plug in the device to a power source, and recharge such device. This may be inconvenient and troublesome if the user forgets to plug in or otherwise charge a device, the device may run out of power and be of no use to the user until the user is again able to charge the device.

For the foregoing reasons, there is a need for a wireless power transmission system where electronic devices may be powered without requiring extra chargers or plugs, and where the mobility and portability of electronic devices may not he compromised.

### SUMMARY OF THE INVENTION

The present disclosure provides a methodology for multiple pocket-forming. The methodology includes at least one transmitter and two or more receivers. A transmitter may include a housing having at least two antenna elements, at least one radio frequency integrated circuit (RFIC), and at least one digital signal processor or micro-controller which may be connected to a power source. The housing may also include a communications component. A receiver may include a housing having at least one antenna element, one rectifier, one power converter, and one or more communications component.

The method for multiple pocket-forming may start when receivers generate short signals (e.g., Radio Frequency) through one or more antenna elements. The transmitter, which may have two or more antenna elements, intercepts these signals and sends them to a micro-controller. The micro-controller decodes the signals and identifies the gain and phase from the signals sent by each receiver, and hence determining the direction of the pocket of energy. The latter may form channels or paths between the transmitter and receivers. Once the channels are established, the transmitter may transmit controlled Radio Frequency (RF) waves which may converge in 3-d space. These RF waves may be controlled through phase and/or relative amplitude adjustments to form constructive and destructive interference patterns (multiple pocket-forming). A receiver may then utilize pockets of energy produced by multiple pocket-forming for charging or powering multiple electronic devices and thus effectively providing wireless power transmission.

In addition, an adaptive power focusing technique is disclosed. This technique may be implemented when there may be obstacles interfering the signals between the receivers and the transmitter or for regulating power at two or more receivers, In an embodiment, receivers and transmitter may use the advantage of having omni-directional antennas, hence allowing the signal to bounce over the walls or ceilings inside a room until establishing a path among them.

The methodology described in the present disclosure may provide wireless power transmission while eliminating the use of wires or pads for charging devices which may require tedious procedures such as plugging to a wall, and may turn devices unusable during charging, These and other advantages of the present disclosure may be evident to those skilled in the art, or may become evident upon reading the detailed description of the prefer embodiment, as shown in the accompanying drawings.

### BRIEF DESCRIPTION OF THE DRAWINGS

Embodiments of the present disclosure are described by way of example with reference to the accompanying figures, which are schematic and may not be drawn to scale. Unless indicated as representing prior art, the figures represent aspects of the present disclosure.

FIG, 1 shows an example of a transmitter that can be used for multiple pocket-forming, according to an embodiment.

FIG. 2 shows an example of a receiver that can be used for multiple pocket-forming, according to an embodiment.

FIG. 3 is an exemplary illustration of a method for multiple pocket-forming, according to an embodiment.

FIG. 4 is an exemplary illustration of an adaptive power focusing technique for multiple pocket-forming, according to an embodiment.

### DETAILED DESCRIPTION OF THE DRAWINGS

“Pocket-forming” may refer to generating two or more RE waves which converge in 3-d space, forming controlled constructive and destructive interference patterns.

“Pockets of energy” may refer to areas or regions of space where energy or power may accumulate in the form of constructive interference patterns of RF waves.

“Null-space” may refer to areas or regions of space where pockets of energy do not form because of destructive interference patterns of RF waves.

“Transmitter” may refer to a device, including a chip which may generate two or more RE signals, at least one RE signal being phase shifted and gain adjusted with respect to other RF signals, substantially all of which pass through one or more RF antenna such that focused RF signals are directed to a target.

“Receiver” may refer to a device including at least one antenna element, at least one rectifying circuit and at least one power converter, which may utilize pockets of energy for powering, or charging an electronic device.

“Adaptive pocket-forming” may refer to dynamically adjusting pocket forming to regulate power on one or more targeted receivers.

### DESCRIPTION OF THE DRAWINGS

In the following detailed description, reference is made to the accompanying drawings, which form a part hereof, in the drawings, which may not be to scale or to proportion, similar symbols typically identify similar components, unless context dictates otherwise. The illustrative embodiments described in the detailed description, drawings and claims, are not meant to be limiting. Other embodiments may be used and/or and other changes may be made without departing from the spirit or scope of the present disclosure.

FIG. 1 shows an example of a transmitter 100 that can be used for multiple pocket-forming. In this embodiment, transmitter 100 may be used to provide wireless power transmission. Transmitter 100 may include a housing 102 having at least two or more antenna elements 104, at least one RF integrated circuit (RFIC 106), at least one digital signal processor (DSP) or micro-controller 108, and one communications component 110. Housing 102 may be made of any suitable material which may allow for signal or wave transmission and/or reception, for example plastic or hard rubber. Antenna elements 104 may include suitable antenna types for operating in frequency bands such as 900 MHz, 2.5 GHz or 5.8 GHz as these frequency bands conform to Federal Communications Commission (FCC) regulations part 18 (Industrial, Scientific and Medical equipment). Antenna elements 104 may include vertical or horizontal polarization, right hand or left hand polarization, elliptical polarization, or other suitable polarizations as well as suitable polarization combinations. Suitable antenna types may include, for example, patch antennas with heights from about 1/24 inches to about 1 inch and widths from about 1/24 inches to about 1 inch. Micro-controller 108 may then process information sent by a receiver. Typically, receivers may communicate to transmitter 100 through short signals (such as RP) or through communications component 110 for determining optimum times and locations for pocket-forming. Communications component 110 may be based on standard wireless communication protocols which may include Bluetooth, Wi-Fi or ZigBee. In addition, communications component 110 may be used to transfer other information such as an identifier for the device or user, battery level, location or other such information. Other communications component 110 may be possible which may include radar, infrared cameras or sound devices for sonic triangulation for determining the device's position. Transmitter 100 may also include an external power source 112.

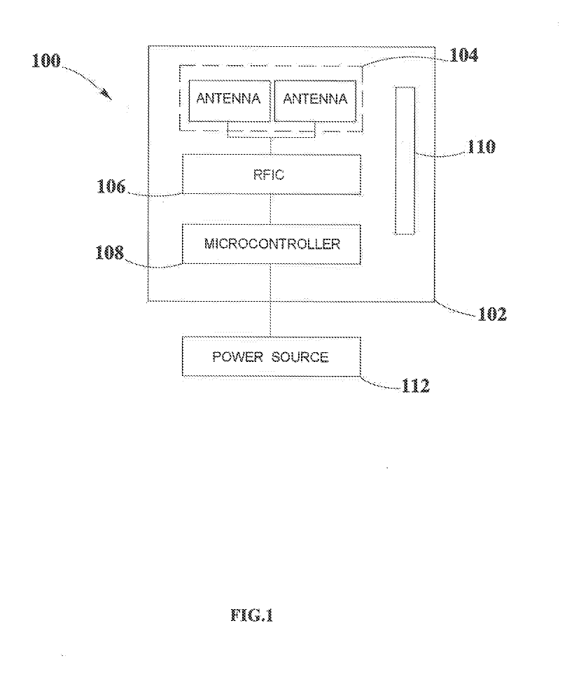

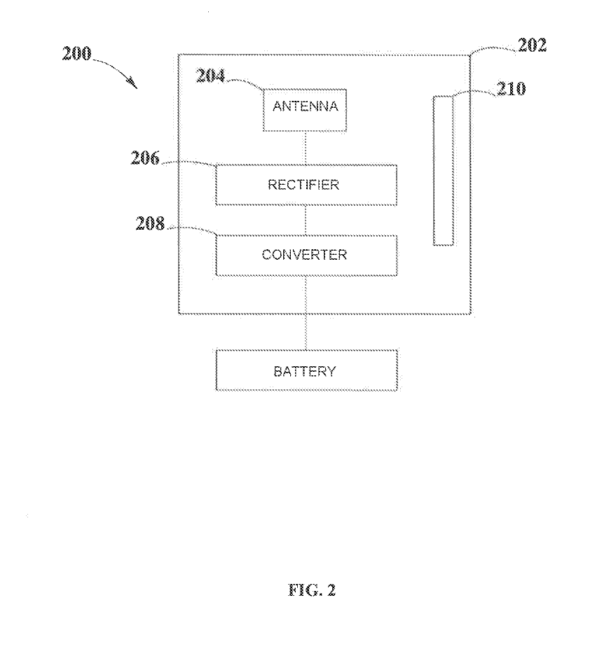

FIG. 2 shows an example of a receiver 200 that can be used for multiple pocket-forming. In this embodiment, receiver 200 may he used for powering or charging an electronic device. Receiver 200 may also include a housing 202 having at least one antenna element 204, one rectifier 206, one power converter 208 and one or more communications component 210. Housing 202 can be made of any suitable material which may allow for signal or wave transmission and/or reception, for example plastic or hard rubber. Housing 202 may be an external hardware that may be added to different electronic equipment, for example in the form of cases, or can be embedded within electronic equipment as well. Antenna element 204 may include suitable antenna types for operating in frequency bands such as those described for transmitter 100 from FIG. 1. Antenna element 204 may include vertical or horizontal polarization, right hand or left hand polarization, elliptical polarization, or other suitable polarizations as well as suitable polarization combinations. As described above, receiver 200 may communicate with transmitter 100 using short signals (such as RF) or through communications component 210 as described in FIG. 1.

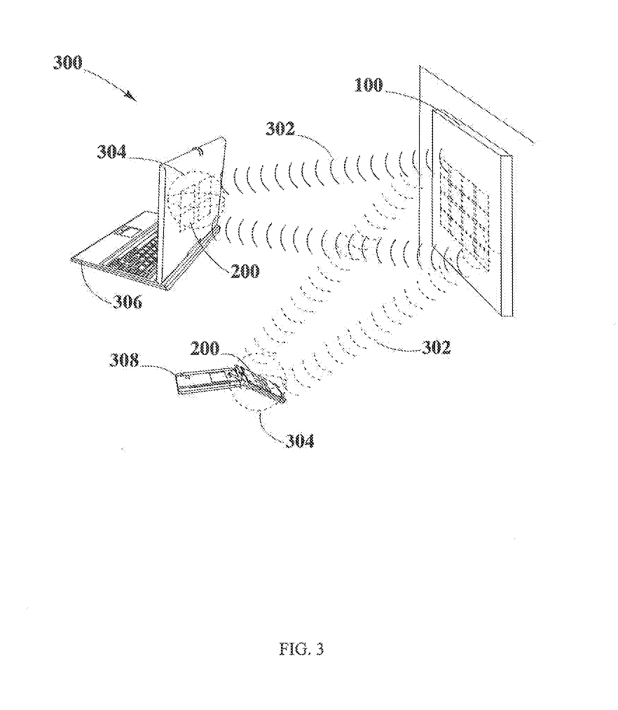

FIG. 3 illustrates wireless power transmission using multiple pocket forming 300 which may include one transmitter 100 and at least two or more receivers 200. Receivers 200 may communicate with transmitter 100 as described above though FIG. 1 and FIG. 2. Once transmitter 100 identifies and locates receiver 200, a channel or path can be established by knowing the gain and phases coming from receiver 200. Transmitter 100 may start to transmit controlled Radio Frequency (RE) waves 302 which may converge in 3-d space by using a minimum of two antenna elements 104. These RF waves 302 may be produced using an external power source 112 and a local oscillator chip using a suitable piezoelectric material. RF waves 302 may be controlled by RFIC 106 which may include a proprietary chip for adjusting phase and/or relative magnitudes of RF signals which may serve as inputs for antenna elements 104 to form constructive and destructive interference patterns (pocket-forming). Pocket-forming may take advantage of interference to change the directionality of the antenna elements 104 where constructive interference generates a pocket of energy 304 and deconstructive interference generates a null space. Receiver 200 may then utilize pocket of energy 304 produced by pocket-forming for charging or powering an electronic device, for example a laptop computer 306 and a smartphone 308 and thus effectively providing wireless power transmission.

Multiple pocket-forming 300 may be achieved by computing the phase and gain from each antenna of transmitter 100 to each receiver 200. The computation may be calculated independently because multiple paths may be generated by antenna element 104 from transmitter 100 to antenna element 204 from receiver 200.

An example of the computation for two antenna elements 104 may be as follow (in terms of signals A and B): (A+B) for the first antenna and (A−B) for the second antenna. One receiver 200 may be at a point where (A+B)+(A−B)=2A. For a second receiver 200 located at some other point, the computation may vary such as (A+B)−(A−B)=2B. This computation may easily be expanded to any number of antenna elements 104.

In some embodiments, two or more receivers 200 may operate at different frequencies to avoid power losses during wireless power transmission. This may be achieved by including multiple embedded antenna elements 104 in an array of transmitter 100. In one embodiment, a single frequency may be transmitted by each antenna in the array. For example, ½ of the antennas in the array may operate at 2.4 GHz while the other ½ may operate at 5.8 GHz. In another example, ⅓ of the antennas in the array may operate at 900 MHz, another ⅓ may operate at 2.4 and the remaining antennas in the array may operate at 5.8 GHz.

In another embodiment, a single antenna element 104 may be virtually divided into several antennas during wireless power transmission. For example, one antenna element 104 may transmit 2.4 GHz, but a receiver 200 may require 5.8 GHz; thus, antenna element 104 may be virtually divided in 4 patches which may be fed independently. As a result, ¼ of this antenna element 104 may be able to transmit the 5.8 GHz needed for receiver 200. Therefore, by virtually dividing a single antenna element 104, power losses during wireless power transmission may be avoided. The foregoing may be beneficial because, for example, one antenna, element 104 transmitting at about 2.4 GHz may be divided into 4 antennas transmitting at 5.8 GHz, and thus, reducing the number of antenna elements 104 in a given array when working with receivers 200 operating at different frequencies.

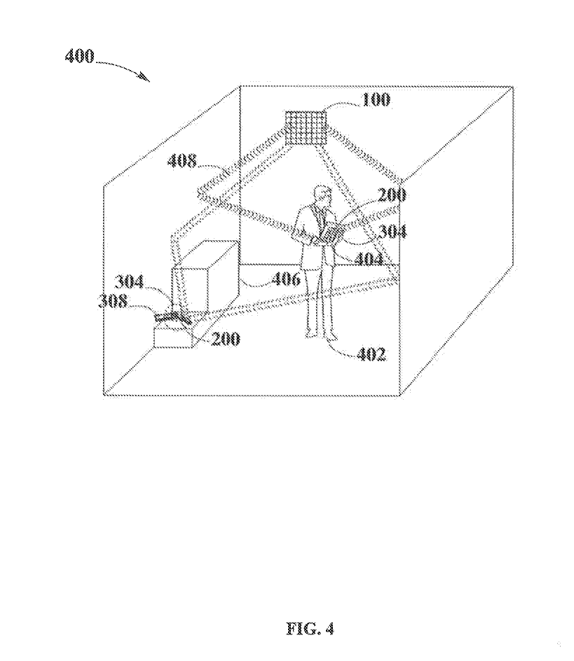

FIG. 4 is an exemplary illustration of multiple adaptive pocket-forming 400. In this embodiment, a user 402 may be inside a room and may hold on his hands an electronic device which in this case may be a tablet 404. In addition, smartphone 308 may be on furniture 406 inside the room. Tablet 404 and smartphone 308 may each include a receiver 200 either embedded to each electronic device or as a separate adapter connected to tablet 404 and smartphone 308. Receivers 200 may include all the components described in FIG. 2.

A transmitter 100 may be hanging on one of the walls of the room right behind user 402, as shown in FIG. 4. Transmitter 100 may also include all the components described in FIG. 1. As user 402 may seem to be obstructing the path between receiver 200 and transmitter 100. RF waves 408 may not be easily aimed to each receiver 200 in a linear direction. However, since the short signals generated from receivers 200 may be omni-directional for the type of antenna elements 104 used, these signals may bounce over the walls until they find transmitter 100. Almost instantly, a micro-controller 108 which may reside in transmitter 100, may recalibrate the signals, sent by each receiver 200, by adjusting gain and phases and forming conjugates taking into account the built-in phases of antenna elements 104. Once calibration is performed, transmitter 100 may focus RE waves 408 in two channels following the paths described in FIG. 4, which may be the most efficient paths. Subsequently, a pocket of energy 304 may form on tablet 404 and another pocket of energy 304 in smartphone 308 while avoiding obstacles such as user 402 and furniture 406. The foregoing property may be beneficial in that wireless power transmission using multiple pocket-forming 300 may inherently be safe as signals may never go through living tissue or other such obstacles.

While various aspects and embodiments have been disclosed herein, other aspects and embodiments may be contemplated. The various aspects and embodiments disclosed herein are for purposes of illustration and are not intended to be limiting, with the true scope and spirit being indicated by the following claims.

Having thus described the invention, I claim:

1. A method for multiple pocket-forming in wireless power transmission to a portable electronic device, comprising:
sending short RF signals from a receiver through an antenna;
intercepting the short RF signals by an antenna in a transmitter having at least two antennas with a micro-controller for processing the RF signals;
decoding the RF signals to identify the gain and phase to determine the direction of the receiver;
transmitting pockets of energy consisting of RF waves from the transmitter through the at least two RE antennas to the receiver;
establishing channels or paths between the transmitter and the receiver for transmitting RF waves to converge in 3-D space with phase or relative amplitude adjustments to form constructive interference patterns for multiple pocket-forming to power the portable electronic device.

2. The method for multiple pocket-forming in wireless power transmission to a portable electronic device of claim 1, further including rectifying the RF waves from the multiple pockets of energy and converting the rectified RF waves into a constant DC voltage for charging or powering the portable electronic device.

3. The method for multiple pocket-forming in wireless power transmission to a portable electronic device of claim 1, further including implementing an adaptive power focusing to avoid obstacles interfering with the RF signals between the receiver and the transmitter for regulating two or more receivers providing charging or powering of the portable electronic device.

4. The method for multiple pocket-forming in wireless power transmission to a portable electronic device of claim 1, wherein the receiver and transmitter include omni-directional antennas and the method further including allowing the RF signals to bounce over the walls or ceiling inside a room until a path or channel is established between the transmitter and receiver.

5. A system for multiple pocket-forming in wireless power transmission to a portable electronic device, comprising:
a transmitter having at least two RF antennas, at least one RE integrated circuit for generating RE waves, a digital signal processor and a first communication circuitry operating on short RF signals;
a receiver with an RF antenna including power circuitry for generating pockets of energy and a second communication circuitry for generating short RE signals to the transmitter to determine optimum times and locations for multiple pocket-forming to converge RE waves in 3-D space for receiving the pockets of energy and for converting the pockets of energy into a constant DC voltage to fully or partially power the portable electronic device.

6. The system for multiple pocket-forming in wireless power transmission to a portable electronic device of claim 5, wherein the first and second communication circuitry is based on standard wireless communication protocols including Bluetooth, Wi-Fi or ZigBee transmitted between the RE antennas of the transmitter and receiver.

7. The system for multiple pocket-forming in wireless power transmission to a portable electronic device of claim 5, wherein the first and second communication circuitry include radar, infrared cameras or sound devices for sonic triangulation for determining the position of the portable electronic device for multiple pocket-forming to converge the RE waves in 3-d space for pockets of energy for charging or powering the electronic device.

8. The system for wireless power transmission to improve battery life in a portable electronic device of claim 5, wherein the portable electronic device is a wristwatch, a headset or other portable electronic device running on small or coin size batteries for a main power supply.

9. The system for multiple pocket-forming in wireless power transmission to a portable electronic device of claim 5, wherein the antennas are made of plastic, rubber or other suitable material for transmission and reception of power or communication RE waves or RE signals, respectively, for operating in frequency bands of 900 MHz, 2.5GHz or 5.8 GHz and wherein the antennas include vertical or horizontal polarization, right hand or left hand polarization, elliptical polarization or other suitable polarizations or any combination thereof.

10. A system for multiple pocket-forming in wireless power transmission to a portable electronic device, comprising:
a transmitter for generating RF waves and short RF signals having at least two RF antennas to transmit the generated RF waves through the antennas in constructive interference patterns;
a first micro-controller within the transmitter for controlling constructive interference patterns of the generated RF waves to form pockets of energy in predetermined areas or regions in 3-D space and for controlling first communication circuitry;
a receiver embedded within the portable electronic device with at least one antenna to receive the pockets of energy in the predetermined regions in 3-D space;
a second micro-controller within the receiver for communicating the power requirements of the portable electronic device to the micro-controller in the transmitter; and
an external power source with a local oscillator connected to the first micro-controller for controlling a RF integrated chip to adjust phase and relative magnitudes of the RF waves to form constructive interference patterns or multiple pocket-forming to converge pockets of energy in 3-d space to charge or power at least one portable electronic device.

11. The system for multiple pocket-forming in wireless power transmission to a portable electronic device of claim 10, wherein the multiple pocket-forming computes the phase and gain from each antenna of the transmitter to each antenna of the receiver and wherein the calculations are independent form one another because of multiple paths generated by antenna from the transmitter to each antenna of the receiver.

12. The system for multiple pocket-forming in wireless power transmission to a portable electronic device of claim 10, wherein the two or more receivers operate at different frequencies to avoid power losses during wireless power transmission.

13. The system for multiple pocket-forming in wireless power transmission to a portable electronic device of claim 10, further including multiple embedded antennas in an array of the transmitter wherein a single frequency is transmitted by each antenna array.

14. The system for multiple pocket-forming in wireless power transmission to a portable electronic device of claim 13, wherein the antennas in the array operate at 2.4 GHz while another array operates at 5.8 GHz.

15. The system for multiple pocket-forming in wireless power transmission to a portable electronic device of claim 11, wherein the first and second micro-controllers communicate on standard wireless communication protocols of Bluetooth, Wi-Fi or Zigbee.

16. The system for multiple pocket-forming in wireless power transmission to a portable electronic device of claim 13, wherein of claim 10, wherein the antennas operate in frequency bands of 900 MHz, 2.5 GHz or 5.8 GHz bands.

17. The system for wireless power transmission to improve battery life in a portable electronic device of claim 10, wherein the antenna is divided into several antennas during wireless power transmission to match the frequency required by each receiver while avoiding wireless power transmission power losses in the transmission of the multiple pocket-forming to converge pockets of energy corresponding to the needs of each receiver connected to different portable electronic devices.

18. The system for multiple pocket-forming in wireless power transmission to a portable electronic device of claim 10, wherein further including multiple adaptive pocket-forming inside a room to multiple portable electronic devices including a tablet, a smartphone and a notebook computer each having the receiver embedded therein or the receiver as a separate adapter connected thereto to charge or power multiple portable electronic devices with pockets of energy having different frequencies according to the electronic device being charged or powered.

19. The system for multiple pocket-forming in wireless power transmission to a portable electronic device of claim 10, wherein the transmitter is hanged on a wall of a room for transmitting the multiple pocket-forming to converge pockets of energy in and space to each portable electronic device within the room to avoid obstacles.

20. The system for multiple pocket-forming in wireless power transmission to a portable electronic device of claim 11, wherein the micro-controller within the transmitter recalibrates the RF signals sent from each receiver to adjust gain and phase to form conjugates taking into account the built-in phase of each omni-directional antenna to focus the RF waves in two channels following the paths that are the most efficient paths to form pockets of energy on each receiver that avoids obstacles or living tissue through multiple pocket-forming.
